(19) United States
(12) Patent Application Publication
(10) Pub. No.: US 2011/0262852 A1
(43) Pub. Date: Oct. 27, 2011

(54) DECOLORIZABLE ELECTROPHOTOGRAPHIC TONER

(75) Inventor: Toshiaki YAMAUCHI, Kanagawa (JP)

(73) Assignee: TOSHIBA TEC KABUSHIKI KAISHA, Tokyo (JP)

(21) Appl. No.: 13/048,197

(22) Filed: Mar. 15, 2011

Related U.S. Application Data
(60) Provisional application No. 61/328,375, filed on Apr. 27, 2010.

(51) Int. Cl. G03G 13/20; G03G 9/087; G03G 9/08

(52) U.S. Cl. 430/108.1; 430/105; 430/109.4; 430/124.1

(57) ABSTRACT

A heat-decolorizable toner of an embodiment of the present invention includes a heat-decolorizable color material, a binder resin, and a foaming agent.

### CROSS-REFERENCE TO RELATED APPLICATION

This application is based upon and claims the benefit of priority from provisional U.S. Patent Application 61/328,375 filed on Apr. 27, 2010, the entire contents of which are incorporated herein by reference.

### FIELD

The present invention relates to decolorizable toners for use in electrophotographic processes.

### BACKGROUND

In image formation using electrophotographic processes, toners of uniform particle diameters of about 4 to 20 μm prepared by dispersing a coloring agent such as a pigment in binder resin are used as the pixel unit.

A system that enables reuse of paper by the heat treatment of printed papers with the use of heat-decolorizable color material for the toner, and that therefore reduces the amount of paper resource and the energy required for the deinking process of the paper is proposed for the effective use of resources and for the reduction of carbon dioxide gas emissions.

A problem of this system, however, is that the toner decoloring process of the paper is time consuming.

### DETAILED DESCRIPTION

Reference will now be made in detail to the present embodiment of the invention, an example of which is illustrated in the accompanying drawing.

In view of this problem, the present inventors looked for ways to reduce the toner decoloring process time, by studying color materials that can be decolored at lower temperatures. Use of color materials that are decolored at low temperatures requires setting low fuse temperatures for the transfer medium to prevent the toner from being decolored by the heat of fusing the toner to the transfer medium. For this reason, the binder resin blended to the toner needs to have a low melting point so that it can be fused at low temperatures.

However, while the toner using a low-melting-point binder resin can reduce the decoloring process time of the toner image it produces, the heat of fusing and decoloring the toner image melts the binder resin in the toner image to such an extent that the toner image surface becomes glossy and smooth.

The toner using a low-melting-point binder resin is thus problematic, because while the color of the color material itself in an image can be erased, the toner leaves a gloss, which makes the decolored portions of the toner image noticeable by reflection of light.

Over these backgrounds, the present inventors looked at the gloss and smoothness of the toner surface, and solved the foregoing problem by roughing the toner surface. Specifically, the present inventors conducted intensive studies to reduce the glossiness on a toner surface caused by low-melting-point binder resin, and found that the gloss can be reduced by roughing the toner surface with a gas generated in the toner during the heat-decoloration of the toner designed to include a substance that generates gas in response to heat. The present invention was completed based on this finding.

The present invention can improve heat-decoloration by roughing the toner surface and thus lowering the smoothness with the use of a foaming agent blended into the decolorizable toner and that generates gas in response to heat. Specifically, a decolorizable electrophotographic toner according to the present invention includes at least a heat-decolorizable color material, a binder resin, and a foaming agent.

The heat-decolorizable color material used in an embodiment of the invention is configured to include at least a color-forming compound as a precursor of a dye, a color-developing agent that interacts with the color-forming compound (mainly by donating or accepting electrons or protons) to develop color, and a decoloring agent that causes decoloration by weakening the interaction.

According to the embodiment of the invention, a heat-decolorizable toner can be provided that can reduce the toner image decoloring process on a transfer medium, and can reliably decolor the toner image on the transfer medium.

A heat-decolorizable toner according to the embodiment of the invention includes a heat-decolorizable color material, a binder resin, and a foaming agent. With the foaming agent contained in the toner, air bubbles generate during the heating with a decoloring apparatus, and roughen the printed toner image surface to suppress glossiness (gloss) and to thereby ensure the decoloration of the toner image.

The configuration of the heat-decolorizable toner according to the embodiment of the present invention is described below in detail.

The heat-decolorizable color material used in the present embodiment is configured from at least a color-forming compound, a color-developing agent, and a decoloring agent. As required, additional components such as a decoloration temperature adjuster may be appropriately combined to provide a configuration that enables decoloration at or above a certain temperature.

Known leuco dyes are generally used as the color-forming compound used in the present embodiment. The leuco dye is an electron-donating compound that can develop color with the color-developing agent, as will be described later. Examples of the leuco dye include diphenylmethanephthalides, phenylindolylphthalides, indolylphthalides, diphenylmethaneazaphthalides, phenylindolylazaphthalides, fluorans, styrylquinolines, and diazarhodamine lactones.

Specific examples include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrrano(2,3-d)pyrimidine-5,1′(3′H)isobenzofuran]-3′-one, 2-(diethylamino)-8-(diethylamino)-4-methyl-, spiro[5H-(1)benzopyrrano(2,3-d)pyrimidine-5,1′(3′H)isobenzofuran]-3′-one, 2-(di-n-butylamino)-8-(di-n-butylamino)-4-methyl-, spiro[5H-(1)benzopyrrano(2,3-d)pyrimidine-5,1′(3′H)isobenzofuran]-3′-one, 2-di-n-butylamino)-8-(diethylamino)-4-methyl-, spiro[5H-(1)benzopyrrano(2,3-d)pyrimidine-5,1′(3′H)isobenzofuran]-3′-one, 2-(di-n-butylamino)-8-(N-ethyl-N-i-amylamino)-4-methyl-, spiro[5H-(1)benzopyrrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Other examples include pyridine, quinazoline, and bisquinazoline compounds. These may be used either alone or as a mixture of two or more. By appropriately selecting color-forming compounds such as above, various color states of many different colors can be obtained.

The content of the color-forming compound is preferably 1% to 20% of all toners. Less than 1%, the color becomes insufficient and image density lowers. Above 20%, image density increases, but decoloration tends to be insufficient, and the increased solid content impairs fusibility. The preferred content of the color-forming compound is 2% to 15%.

The color-developing agent used in the present embodiment is an electron-accepting compound that donates a proton to the electron-donating color-forming compound and thus allows the color-forming compound to develop color. Examples of the color-developing agent include phenols, phenol metal salts, carboxylic acid metal salts, aromatic carboxylic acids, aliphatic carboxylic acids of 2 to 5 carbon atoms, benzophenones, sulfonic acids, sulfonates, phosphoric acids, phosphoric acid metal salts, acidic phosphoric acid esters, acidic phosphoric acid ester metal salts, phosphorous acids, phosphorous acid metal salts, monophenols, polyphenols, 1, 2, 3-triazole and derivatives thereof, either unsubstituted or substituted with substituents such as an alkyl group, an aryl group, an acyl group, an alkoxycarbonyl group, a carboxy group, esters of these, an amide group, and a halogen group. Other examples include bis-, tris-phenols, phenol-aldehyde condensate resins, and metal salts of these. These may be used either alone or as a mixture of two or more.

Specific examples include phenol, o-cresol, t-butylcatechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acids (such as 2,3-dihydroxybenzoic acid and methyl 3,5-dihydroxybenzoate) and esters thereof, resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)n-hexane, 1,1-bis(4-hydroxyphenyl)n-heptane, 1,1-bis(4-hydroxyphenyl)n-octane, 1,1-bis(4-hydroxyphenyl)n-nonane, 1,1-bis(4-hydroxyphenyl)n-decane, 1,1-bis(4-hydroxyphenyl)n-dodecane, 2,2-bis(4-hydroxyphenyl)butane, 2,2-bis(4-hydroxyphenyl)ethylpropionate, 2,2-bis(4-hydroxyphenyl)-4-methylpentane, 2,2-bis(4-hydroxyphenyl)hexafluoropropane, 2,2-bis(4-hydroxyphenyl)n-heptane, 2,2-bis(4-hydroxyphenyl)n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylenetris-p-cresol.

The decoloring agent used in the present embodiment may be a known decoloring agent, provided that it can erase color by inhibiting the chromogenic reaction between the color-forming compound and the color developing agent under heat in the three-component system of the color-forming compound, the color developing agent, and the decoloring agent. Use of decoloring agents that utilize temperature hysteresis is particularly preferable, because such decoloring agents have a color-decolor mechanism offering superior instantaneous erasability.

With the color-decolor mechanism utilizing temperature hysteresis, the color of the three-component system mixture, specifically, the mixture of the color-forming compound, the color-developing agent, and the decoloring agent, can be erased by heating the mixture to a temperature equal to or greater than a specific decoloration temperature (hereinafter, also referred to as “full decoloration temperature” or “Th”). The decolored state can be maintained even after the decolored mixture is cooled down to a temperature below Th. Upon lowering the temperature further, a reversible color-decolor reaction can take place, whereby the chromogenic reaction between the color-forming compound and the color developing agent is restored at or below a specific color restoring temperature (hereinafter, also referred to as “full coloration temperature” or “Tc”) to return to the colored state. Preferably, the decoloring agent used in the present embodiment satisfies the relation Th>Tr>Tc, where Tr is room temperature (25° C.)

The decoloring agent that can exhibit such temperature hysteresis may be, for example, alcohols, esters, ketones, ethers, and acid amides known from, for example, JP-A-60-264285, JP-A-2005-1369, and JP-A-2008-280523. Of these, esters are particularly preferred. Specific examples include carboxylic acid esters that contain a substituted aromatic ring; esters of unsubstituted aromatic ring-containing carboxylic acid and aliphatic alcohol; carboxylic acid esters that contain a cyclohexyl group within the molecule; esters of fatty acid and unsubstituted aromatic alcohol or phenol; esters of fatty acid and branched aliphatic alcohol; esters of dicarboxylic acid and aromatic alcohol or branched aliphatic alcohol; dibenzyl cinnamate; heptyl stearate; didecyl adipate; dilauryl adipate; dimyristyl adipate; dicetyl adipate; distearyl adipate; trilaurin; trimyristin; tristearin; dimyristin; and distearin. These may be used either alone or as a mixture of two or more.

The proportions of the color-forming compound, the color-developing agent, and the decoloring agent as a color material mixture are preferably such that the color-developing agent is 0.5 to 20 parts with respect to 1 part by mass of the color-forming compound, though it depends on the concentration, the color developing temperature, and the type of each component. Color becomes insufficient with a color-developing agent content less than 0.5 parts. Above parts, decoloration becomes insufficient. More preferably, the content of the color-developing agent is 1 to 10 parts. The decoloring agent is preferably 5 to 100 parts with respect to 1 part by mass of the color-forming compound. Decoloration becomes insufficient with a decoloring agent content less than 5 parts. Above 100 parts, color becomes insufficient from the beginning. More preferably, the content of the decoloring agent is 10 to 75 parts.

Decoloration can be accelerated by encapsulating the color materials with a shell component. The method of encapsulation may be, for example, an interfacial polymerization method, a coacervation method, an In-situ polymerization method, a drying-in-liquid method, or a harden-and-coating-in-liquid method. Of these, the In-Situ method that uses a melamine resin as the shell component, and the interfacial polymerization method that uses a urethane resin as the shell component are particularly preferred.

In the In-Situ method, the three components of the color material are dissolved and mixed, and emulsified in an aqueous solution of a water-soluble polymer or a surfactant. These components can then be encapsulated by heat polymerization with addition of a melamine formalin prepolymer aqueous solution. In the interfacial polymerization method, the three components of the color material and a polyvalent isocyanate prepolymer are dissolved and mixed, and emulsified in an aqueous solution of a water-soluble polymer or a surfactant. The components can then be encapsulated by heat polymerization with addition of a polyvalent base such as diamine and diol.

The binder resin used in the present embodiment is not particularly limited, as long as it is a resin with a low melting point or a low glass transition point Tg that can be fused at a temperature lower than the decoloration temperature of the mixed color material. Examples include polyester resin, polystyrene resin, styrene and acrylate copolymer resin, polyester-styrene and acrylate hybrid resin, epoxy resin, and polyether.polyol resin. Binder resins such as above may be appropriately selected according to the mixed color material.

The binder resin content in all toners is preferably 70% to 97%. Fusibility suffers with a buffer resin content less than 70%. Above 97%, the effects of the color components or charge control component become insufficient. More preferably, the binder resin content is 80% to 95%.

The foaming agent used in the present embodiment is not particularly limited, as long as it is a substance that generates gas in response to heat. The foaming agent can be appropriately selected taking into account toner characteristics or usability during the manufacture, so that the foaming agent starts decomposing at or below the set temperature of the decoloration apparatus. Both inorganic foaming agents and organic foaming agents can be used as such foaming agents.

Examples of inorganic foaming agents include sodium bicarbonate, ammonium carbonate, ammonium bicarbonate, and calcium azide. Examples of organic foaming agents include p,p′-oxybisbenzenesulfonylhydrazide, dinitrosopentamethylenetetramine, azodicarboxylic amide, hydrazodicarboxylic amide, and azobisisobutyronitrile. Foaming agents such as above may be appropriately selected from materials that start decomposing at or below the set temperature of the decoloration apparatus, taking into account the toner characteristics or usability during the manufacture.

The content of the foaming agent in all toners should be set in a range of preferably from 0.01% to 10%, taking into consideration the balance between the foaming and deglossing effects and toner characteristics. Foaming becomes insufficient and the deglossing effect becomes weak with a foaming agent content less than 0.01%. Above 10%, foaming becomes excessive, and the fused toner image expands and impairs image quality.

The heat-decolorizable toner of the present embodiment may contain waxes to control toner fusibility for transfer medium. The waxes used for the decolorizable toner of the present embodiment are preferably configured from components that do not allow the color-forming compound to develop color. Examples of such waxes include natural waxes such as rice wax, and carnauba wax; petroleum waxes such as paraffin wax; and synthetic waxes such as fatty acid ester, fatty acid amide, low molecular polyethylene, and low molecular polypropylene.

The heat-decolorizable toner of the present embodiment may also contain a charge control agent to adjust the charge characteristics of the toner. Because the heat-decolorizable toner of the present embodiment is required not to leave color after decoloration, the charge control agent is preferably colorless or transparent.

Examples of negative charge control agent include E-89 (calixarene derivative; Orient Chemical Industries Co., Ltd.), N-1, N-2, N-3 (phenol compounds), LR147 (boron compound), available from Japan Carlit Co., Ltd., and FCA-1001N (styrene-sulfonic acid resin; Fujikura Kasei Co., Ltd.). Of these, E-89 and LR147 are more preferred. Examples of positive charge control agent include TP-302 (CAS# 116810-46-9), TP-415 (CAS# 117342-25-2), available from Hodogaya Chemical Co., Ltd., P-51 (quaternary amine compound), AFP-B (polyamine oligomer), available from Orient Chemical Industries Co., Ltd., and FCA-201PB (styrene-acryl quaternary ammonium salt resin; Fujikura Kasei Co., Ltd.).

External additives for controlling the fluidity, preservability, anti-blocking property, photoreceptor abradability, and other properties of the decolorizable toner of the present embodiment may also be contained. Examples of such external additives include silica fine particles, metal oxide fine particles, and cleaning auxiliary agents.

Examples of silica fine particles include silicon dioxide, sodium silicate, zinc silicate, and magnesium silicate. Examples of metal oxide fine particles include zinc oxide, magnesium oxide, zirconium oxide, strontium titanate, and barium titanate. Examples of cleaning auxiliary agent include resin fine particles such as polymethylmethacrylate, polyvinylidene fluoride, and polytetrafluoroethylene, and fine powders of metal fatty acid compounds such as zinc stearate and aluminum stearate. These external additives may be subjected to surface treatment such as a hydrophobic treatment.

The method and machine used for the toner manufacture are not particularly limited, and known manufacturing methods and machines can be used. Generally, the decolorizable toner of the present embodiment can be manufactured by a method in which, for example, the constituting components of the toner of the present embodiment, including the heat-decolorizable color material, the binder resin, and the foaming agent are uniformly mixed, kneaded, and cooled, and then pulverized and classified to obtain particles of a predetermined size, or by a chemical method in which fine particles of the constituting components are emulsified and dispersed in water, and aggregated to form toner particles, which are then heat fused, filtered, and dried.

In any case, the toner needs to be produced under the temperature conditions that do not decolor the color material during the toner manufacture. After toner particles of about 4 to 20 μm are formed, external additives such as above may be added, and mixed to the toner using a mixer such as a Henschel mixer, as required.

The toner of the present embodiment produced as above is contained in, for example, a toner cartridge, which is attached to an image forming apparatus such as an MFP (Multi-Functional Peripheral) provided with a heat-fuse system, and used for electrophotographic image formation. The toner also can be used in a system in which the toner on paper is decolored at a decoloration temperature higher than the fuse temperature.

The present invention is described below in more detail based on Example and Comparative Examples. It should be noted, however, that the present invention is not limited by the following Examples. In the following, “part” and “%” are part and percent by mass, unless otherwise stated.

### Preparation of Encapsulated Decolorizable Color Fine Particles (Color Material) A

Components including 1 part of the leuco dye 3-(2-ethoxy-4-diethylaminophenyl)-3-(1-ethyl-2-methylindol-3-yl)-4-azaphthalide, 5 parts of the color-developing agent 2,2-bis(4-hydroxyphenyl)hexafluoropropane, and 50 parts of a diester compound of the decoloring agent pimelic acid and 2-(4-benzyloxyphenyl)ethanol were dissolved under heat. After dissolving these components, 20 parts of aromatic polyvalent isocyanate prepolymer, and 40 parts of ethyl acetate were mixed as the encapsulating agent. The resulting solution was charged into 250 parts of an 8% polyvinyl alcohol aqueous solution, emulsified and dispersed, and stirred at 90° C. for about 1 hour. Then, 2 parts of water-soluble aliphatic modified amine was added as a reactant, and the mixture was stirred at the maintained liquid temperature of 90° C. for about 3 hours to obtain colorless capsule particles. The capsule particle dispersion was placed in a freezer to develop color, and dried by solid-liquid separation to obtain blue color particles A.

The color particles A had a volume average particle diameter of 2 μm as measured with an SALD7000 (Shimadzu Corporation). The full decoloration temperature (Th) was 79° C., and the full coloration temperature (Tc) was −10° C.

### Example 1

### Toner Formulation

| | |
|---|---|
| Polyester resin A (Tg; 45° C.) | 84 parts |
| Rice wax | 5 parts |
| Color particles A | 10 parts |
| Sodium bicarbonate | 1 part |

After weighing the materials of this formulation, the materials were uniformly mixed with a Henschel mixer, and kneaded with a biaxial kneader set to a temperature of 80° C. The kneaded toner composition was coarsely comminuted to 2 mm or less with a hammer mill after being cooled with a belt cooler, and particles with an average particle diameter of 8 μm were obtained through an airflow pulverization and classification machine. Thereafter, the external additive hydrophobic silica (2 parts) and titanium oxide (0.5 parts) were added to the particles, and the mixture was passed through a 200-mesh sieve after being mixed with a Henschel mixer. As a result, a toner was obtained. Because the toner so produced is decolored by the heat of kneading, the product toner was cooled for 2 days in a −20° C. freezer to redevelop color.

The toner was mixed with a silicon resin-coated ferrite carrier, and an image was formed with a Toshiba Tec MFP (e-Studio 4520C). The resulting image was evaluated as follows. Note that the MFP fuse temperature was set to 70° C., and the paper feed speed was adjusted to 30 mm/sec.

### Image Density

Measured using an image densitometer RD-918 (Macbeth)

### Glossiness

Measured using the glossiness meter gloss checker IG-320 (Horiba Ltd.)

The color image had an image density of 0.5, and a glossiness of 6.

The disappearance of the color was confirmed after the color image was carried through at a fuser temperature of 100° C. and a paper feed speed of 100 mm/sec. The measured glossiness of the image with the remaining decolored toner was 8, and the residual resin was hardly noticeable.

### Comparative Example 1

### Toner Formulation

| | |
|---|---|
| Polyester resin A (Tg; 45° C.) | 85 parts |
| Rice wax | 5 parts |
| Color particles A | 10 parts |

The materials of this formulation were mixed as in Example 1, and made into the product toner. As in Example 1, the toner was mixed with a silicon resin-coated ferrite carrier, and an image was formed with a Toshiba Tec MFP (e-Studio 4520C). The resulting color image had an image density of 0.52, and a glossiness of 23.

After the decoloring process of the color image performed in the same manner as in Example 1, the glossiness became 26, though the color of the dye was not recognizable. The image with the remaining decolored toner was glossy, and it was difficult to say that the toner image was decolored.

### Comparative Example 2

### Toner Formulation

| | |
|---|---|
| Polyester resin B (Tg; 60° C.) | 85 parts |
| Rice wax | 5 parts |
| Color particles A | 10 parts |

The materials of this formulation were mixed as in Example 1, and made into the product toner. As in Example 1, the toner was mixed with a silicon resin-coated ferrite carrier, and an image formed with a Toshiba Tec MFP (e-Studio 4520C). Because the toner was not fused, the fuser temperature was changed from 70° C. to 120° C. for evaluation. Since this fuser temperature exceeded the decoloration temperature of the color material, the toner image was decolored, and the image density was only 0.08. The glossiness was 8.

After the decoloring process of the image at 150° C., the glossiness was 9, and the residual toner was hardly noticeable. The comparative experiment conducted with the use of the color material of low decoloration temperature revealed that the glossiness problem does not occur as long as a resin having a high Tg and a high fusible temperature is used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions the accompanying claims and their equivalents are intended to cover such forms or modifications as would fall within the scope and spirit of the inventions.

What is claimed is:

1. A heat-decolorizable toner, comprising:
a heat-decolorizable color material;
a binder resin; and
a foaming agent.

2. The toner according to claim 1, wherein the color material includes a color-forming compound, a color-developing agent, and a decoloring agent.

3. The toner according to claim 1, wherein the foaming agent has a decomposition temperature lower than a decoloration temperature, and higher than a fuse temperature.

4. The toner according to claim 1, wherein the content of the foaming agent ranges from 0.01 wt % to 10 wt %.

5. The toner according to claim 1, wherein the foaming agent is sodium bicarbonate.

6. The toner according to claim 2, wherein the color-forming compound is a leuco dye.

7. The toner according to claim 1, wherein the color material is encapsulated in a microcapsule.

8. The toner according to claim 1, wherein the binder resin is a polyester resin.

9. The toner according to claim 1, further comprising a wax.

10. The toner according to claim 9, wherein the wax is a rice wax.

11. A heat-decoloration method, comprising the steps of:
forming a toner image on a medium by heating and fusing a toner that includes a heat-decolorizable color material, a binder resin, and a foaming agent; and
heating the toner image at a temperature higher than the temperature of heating and fusing the toner.

12. The method according to claim 11, wherein the color material includes a color-forming compound, a color-developing agent, and a decoloring agent.

13. The method according to claim 11, wherein the foaming agent has a decomposition temperature lower than the decoloration temperature of the toner image, and higher than the fuse temperature.

14. The method according to claim 11, wherein the content of the foaming agent ranges from 0.01 wt % to 10 wt %.

15. The method according to claim 11, wherein the foaming agent is sodium bicarbonate.

16. The method according to claim 12, wherein the color-forming compound is a leuco dye.

17. The method according to claim 11, wherein the color material is encapsulated in a microcapsule.

18. The method according to claim 11, wherein the binder resin is a polyester resin.

19. The method according to claim 11, wherein the toner further includes a wax.

20. The method according to claim 19, wherein the wax is a rice wax.
